(19) United States
(12) Patent Application Publication
(10) Pub. No.: US 2018/0147699 A1
(43) Pub. Date: May 31, 2018

(54) RATCHET ASSEMBLY

(71) Applicant: Ming-Ta CHENG, Taichung City (TW)

(72) Inventor: Ming-Ta CHENG, Taichung City (TW)

(21) Appl. No.: 15/362,491

(22) Filed: Nov. 28, 2016

(51) Int. Cl. B25B 13/46

(52) U.S. Cl. CPC B25B 13/465

(57) ABSTRACT

A ratchet assembly has a housing and a sleeve fixing device. The housing has a fixing space. The sleeve fixing device is mounted through the housing and has a sleeve fixing element, a rotating element, and a reverting support. The sleeve fixing element is mounted in the fixing space of the housing and has a rotation portion. The rotating element is rotatably mounted through the rotation portion. The reverting support is mounted through the rotating element and has a moveable barrel, a rotating ball, a spring, and an abutting element. The rotating ball is rotatably mounted in one end of the moveable barrel. The spring is mounted in the other end of the movable barrel. The abutting element is mounted into the moveable barrel and around the spring. This may prolong the life cycle of the spring.

### BACKGROUND OF THE INVENTION

### 1. Field of the Invention

The present invention relates to a ratchet assembly, and more particularly to a ratchet assembly that has a prolonged life cycle.

### 2. Description of Related Art

A ratchet wrench has a ratchet element mounted in the ratchet wrench for a user to tighten or loosen a nut. The ratchet element has a reverting support and a spring, and the reverting support is integrally molded as a single part and has a semi-spherical end. The reverting support keeps abutting the ratchet element while the ratchet wrench is in use and is easily worn off. The spring has two ends, and one end of the spring directly abuts against a wall surface of a mounting hole of the ratchet element.

In order to avoid shortening the life cycle of the reverting support by the abrasion in use of the reverting support, a ball is rotatably mounted in a front end of the reverting support and may rotate with the ratchet element. Accordingly, the life cycle of the reverting support can be prolonged. However, the spring directly abuts against the wall surface of the mounting hole of the ratchet element such that the end portion of the spring is pressed against the wall of the fitting hole of the sleeve positioning member. Since the spring directly contacts the wall surface of the mounting hole of the ratchet element, the spring may be distorted after a long time of use.

To overcome the shortcomings of the conventional ratchet assembly, the present invention provides a ratchet assembly to mitigate or obviate the aforementioned problems.

### SUMMARY OF THE INVENTION

The main objective of the present invention is to provide a ratchet assembly that has a prolonged life cycle.

The ratchet assembly with a rolling support structure has a housing and a sleeve fixing device. The housing has a fixing space. The sleeve fixing device is mounted through the housing and has a sleeve fixing element, a rotating element, and a reverting support. The sleeve fixing element is mounted in the fixing space of the housing and has a rotation portion. The rotating element is rotatably mounted through the rotation portion. The reverting support is mounted through the rotating element and has a moveable barrel, a rotating ball, a spring, and an abutting element. The rotating ball is rotatably mounted in one end of the moveable barrel. The spring is mounted in the other end of the movable barrel. The abutting element is mounted into the moveable barrel, and is mounted around the spring. This may prolong the life cycle of the spring.

Other objects, advantages, and novel features of the invention will become more apparent from the following detailed description when taken in conjunction with the accompanying drawing.

### BRIEF DESCRIPTION OF THE DRAWINGS

FIG. 1 is an exploded perspective view of a first embodiment of a ratchet assembly in accordance with the present invention;

FIG. 2 is an enlarged exploded perspective view of a sleeve fixing device of the ratchet assembly in FIG. 1;

FIG. 3 is an enlarged exploded perspective view of a rotating element and a reverting support of the ratchet assembly in FIG. 1;

FIG. 4 is an enlarged operational cross sectional side view of the ratchet assembly in FIG. 1 in a clockwise rotation;

FIG. 5 is an enlarged operational cross sectional side view of the ratchet assembly in FIG. 1 in a counterclockwise rotation; and

FIG. 6 is a cross sectional side view of a second embodiment of a ratchet assembly in accordance with the present invention.

### DETAILED DESCRIPTION OF PREFERRED EMBODIMENT

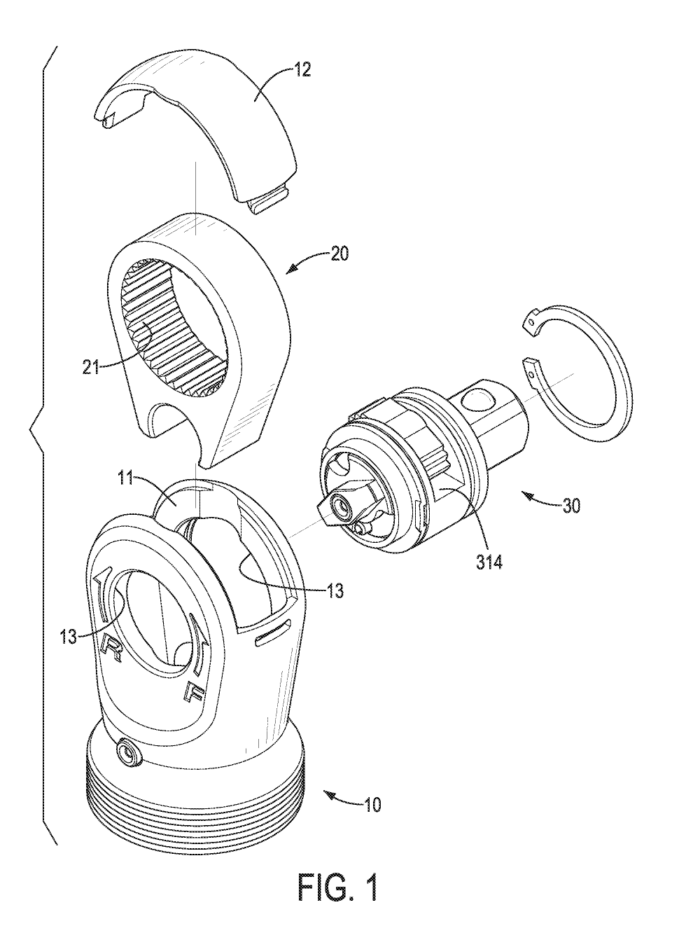

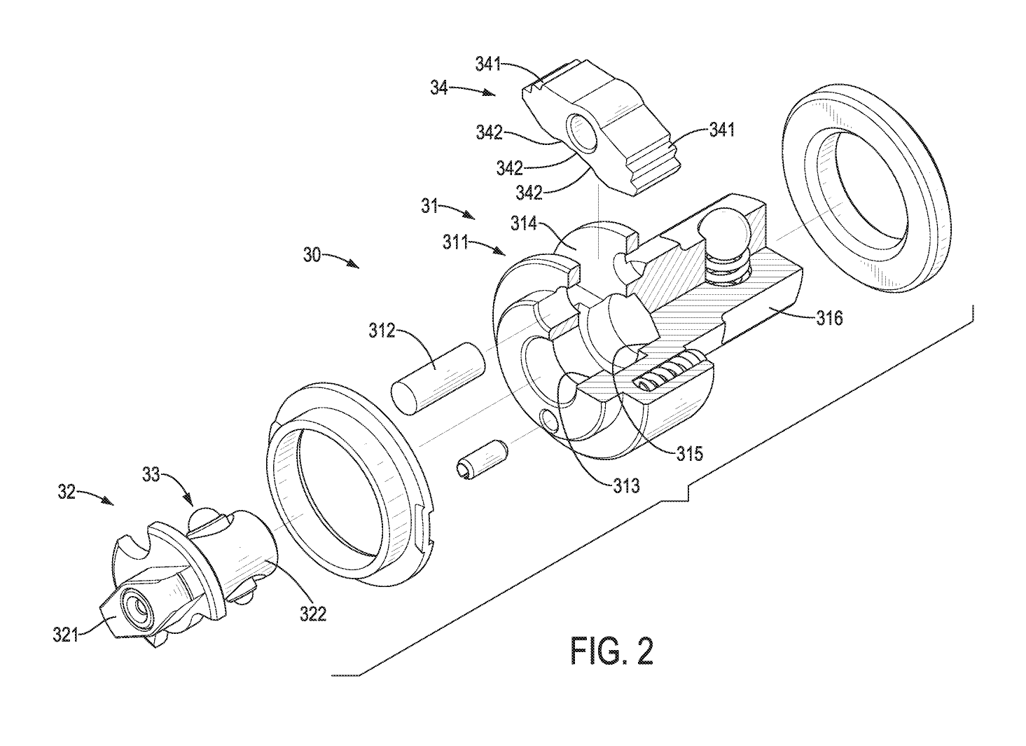

With reference to FIGS. 1 and 2, a first embodiment of a ratchet assembly in accordance with the present invention comprises a housing 10, a ratchet element 20, and a sleeve fixing device 30.

With reference to FIG. 1, the housing 10 is hollow and has a top portion, a front face, a rear face, a fixing space 11, a top cover 12, and two openings 13. The fixing space 11 is formed in the housing 10. The top cover 12 is mounted on the top portion of the housing 10. The two openings 13 are formed through the front face and the rear face of the housing 10 respectively and communicate with the fixing space 11.

With reference to FIGS. 1 and 2, the ratchet element 20 is mounted in the fixing space 11 of the housing 10. The ratchet element 20 has an inner circumferential surface and a toothed face 21. The toothed face 21 is formed on the inner circumferential surface of the ratchet element 20.

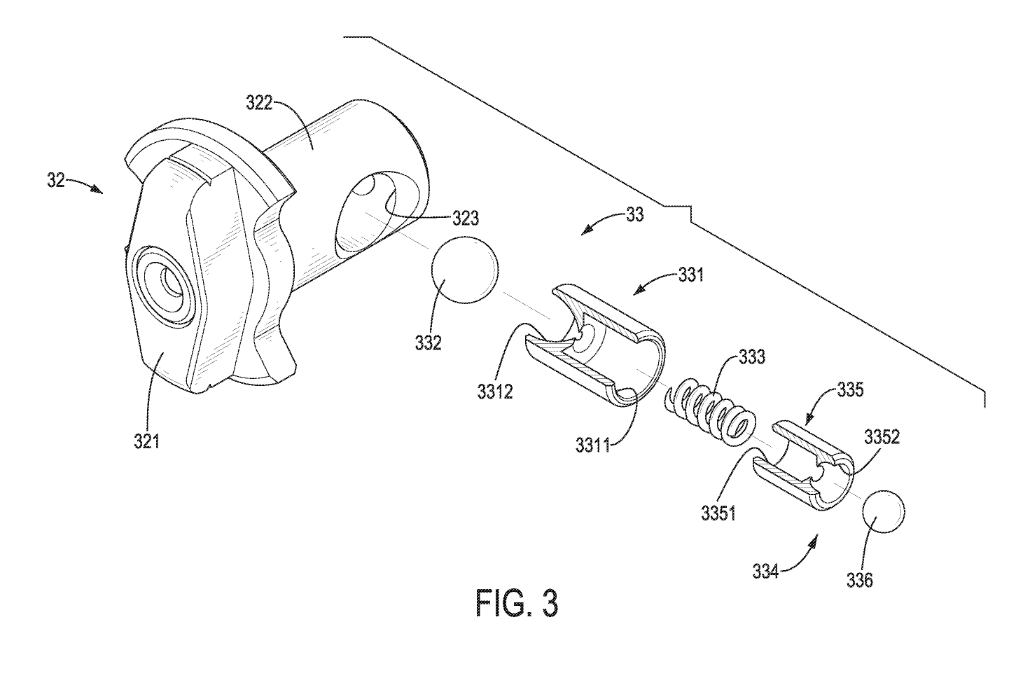

With reference to FIGS. 1 to 3, the sleeve fixing device 30 is mounted through the housing 10 horizontally and is engaged with the ratchet element 20. The sleeve fixing device 30 has a sleeve fixing element 31, a rotating element 32, a reverting support 33, and a ratchet block 34. The sleeve fixing element 31 is mounted in the fixing space 11 of the housing 10, and has a rotation portion 311 and a pivot shaft 312. The rotation portion 311 is a cylinder and has an axis, a front surface, a rear surface, an outer circumferential surface, a mounting hole 313, a mounting recess 314, a connecting hole 315, and a sleeve fixing portion 316. The mounting hole 313 is formed in the front surface of the rotation portion 311. The mounting recess 314 is formed radially in the outer circumferential surface of the rotation portion 311. The mounting recess 314 is semi-circular in shape. The connecting hole 315 is formed between the mounting recess 314 and the mounting hole 313, and communicates with the mounting recess 314 and the mounting hole 313. The sleeve fixing portion 316 axially protrudes from the rear surface of the rotation portion 311. The pivot shaft 312 is mounted through the mounting recess 314 of the rotation portion 311.

The rotating element 32 is mounted through the mounting hole 313 of the rotation portion 311, and has a rotating disk 321, a rotating shaft 322, and a support element mounting hole 323. The rotating disk 321 may rotatably abut the rotation portion 311. The rotating shaft 322 is integrally connected to a side surface of the rotating disk 321. The rotating shaft 322 is a hollow cylinder. The support element mounting hole 323 is formed through an outer surface of the rotating shaft 322.

The reverting support 33 is mounted through the support element mounting hole 323 of the rotating element 32, and extends out of the connecting hole 315 of the rotation portion 311. The reverting support 33 has a moveable barrel 331, a rotating ball 332, a spring 333, and an abutting element 334. The moveable barrel 331 is a cylindrical barrel, and has a first end, a second end, a spring recess 3311 and a ball mounting recess 3312. The spring recess 3311 is formed in the first end of the moveable barrel 331. The ball mounting recess 3312 is formed in the second end of the moveable barrel 331. The second end of the moveable barrel 331 is mounted through the support element mounting hole 323 of the rotating shaft 322. The rotating ball 332 is rotatably mounted in the ball mounting recess 3312, and part of the rotating ball 32 protrudes from the ball mounting recess 3312. The spring 333 is mounted in the spring recess 3311 of the moveable barrel 331 and has two ends. One of the two ends of the spring 333 abuts the moveable barrel 331. The abutting element 334 is mounted into the spring recess 3311 of the moveable barrel 331 and is mounted around the spring 333. In the first embodiment, the abutting element 334 has an abutting barrel 335 and an abutting ball 336. The abutting barrel 335 is a cylindrical barrel and has a first end, a second end, a disposing recess 3351, and an abutting ball recess 3352. The disposing recess 3351 is formed in the first end of the abutting barrel 335, and the other end of the spring 333 is mounted into and abuts a wall of the disposing recess 3351 of the abutting barrel 335. The abutting ball recess 3352 is formed in the second end of the abutting barrel 335. The abutting ball 336 is rotatably mounted in the abutting ball recess 3352 of the abutting barrel 335, and part of the abutting ball 336 protrudes from the abutting ball recess 3352, and this enables the abutting ball 336 to rotatably abut the mounting hole 313 of the sleeve fixing element 31.

The ratchet block 34 is mounted in the mounting recess 314, and is rotatably mounted around the pivot shaft 312. The ratchet block 34 is an elongated block and has an inner surface, an upper end, a bottom end, two engaging faces 341, and three positioning recesses 342. The two engaging faces 341 are formed in the upper end and the bottom end of the ratchet block 34 respectively, the shape and the position of the two engaging faces 341 correspond to the shape and position of the toothed face 21 of the ratchet element 20. The three positioning recesses 342 are formed in the inner surface of the ratchet block 34 and are wave-shaped. The rotating ball 332 of the reverting support 33 elastically engages with one of the positioning recesses 342. The design of the positioning recesses 342 enables the inner surface of the ratchet block 34 to engage with the rotating ball 332 stably.

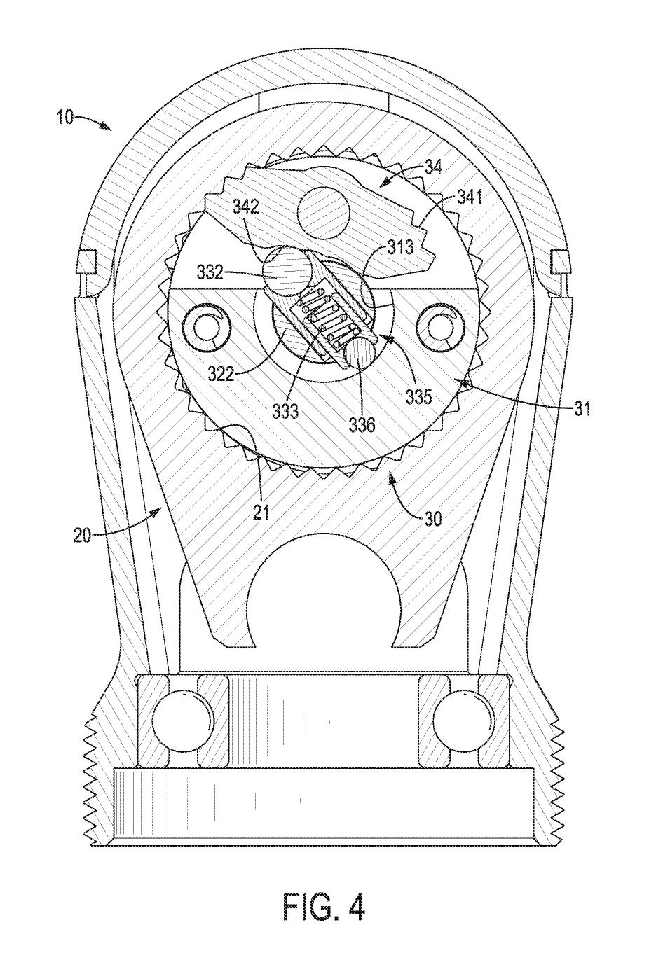

With reference to FIG. 4, when the ratchet assembly in accordance with the invention is in use, the reverting support 33 of the sleeve fixing device 30 abuts one of the positioning recesses 342 of the ratchet block 34, and this enables the ratchet block 34 to swing and rotate. One of the engaging faces 341 of the ratchet block 34 is engaged with the toothed face 21 of the ratchet element 20. Taking clockwise rotation as an example, the engaging face 341 at the upper end of the ratchet block 34 abuts the toothed face 21 of the ratchet element 20. When the sleeve fixing element 31 rotates clockwise, the abutting ball 336 of the abutting element 334 is rotated by force. The design of the abutting ball 336 and the abutting barrel 335 prevents one end of the spring 333 from directly abutting the wall of the mounting hole 313 of the sleeve fixing element 31, and therefore the life cycle of the spring 333 can be prolonged.

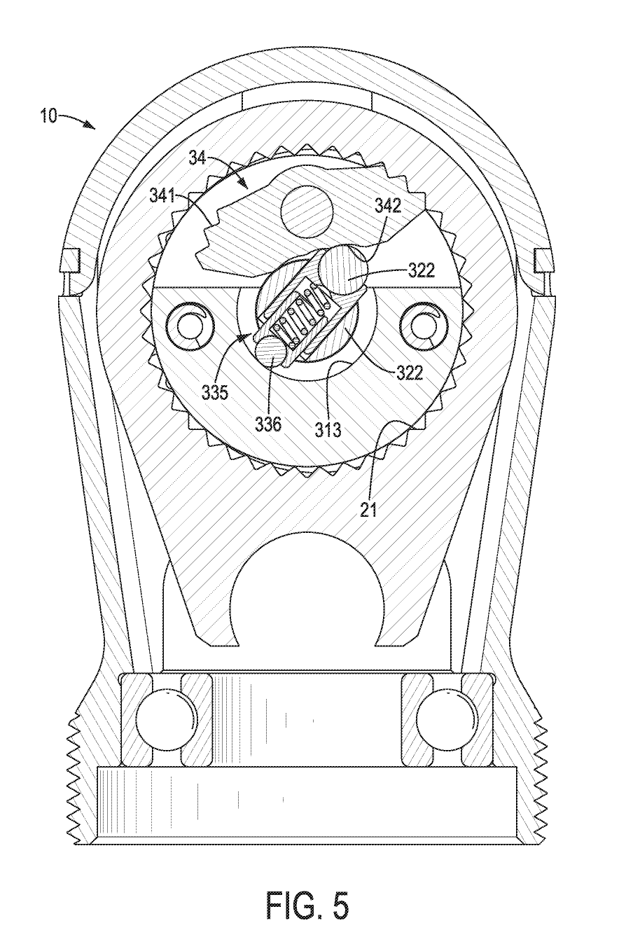

With reference to FIG. 5, the rotating element 32 rotates the reverting support 33 to a position below the ratchet block 34, and this enables the engaging face 341 at the bottom end of the ratchet block 34 to abut the toothed face 21 of the ratchet element 20, and this may keep the sleeve fixing element 31 rotating in the counterclockwise direction to generate an engaging force.

The design of the abutting element 334 enables the abutting ball 336 to rotatably abut a wall of the mounting hole 313 of the sleeve fixing element 31. One end of the spring 333 is prevented from directly abutting the wall of the mounting hole 313 of the sleeve fixing element 31, and the life cycle of the spring 333 can be prolonged.

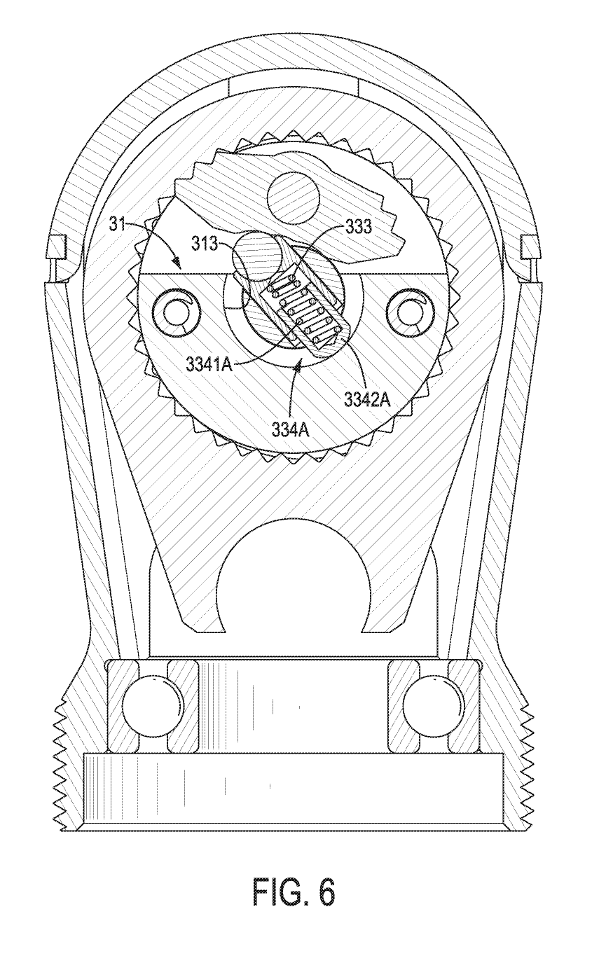

With reference to FIG. 6, a second embodiment of a ratchet assembly in accordance with the present invention is substantially the same as the first embodiment except for the following features. The abutting element 334A is a cylindrical barrel and has a first end, a second end, a receiving recess 3341A, and an abutting protrusion 3342A. The receiving recess 3341A is formed in the first end of the abutting element 334A, and the other end of the spring 333 is mounted in and abuts a wall of the receiving recess 3341A of the abutting element 334A. The abutting protrusion 3342A protrudes from the second end of the abutting element 334A, and the abutting protrusion 3342A is hemispherical. The abutting protrusion 3342A abuts the mounting hole 313 of the sleeve fixing element 31. The operating procedure of the second embodiment of the present invention is similar to the first embodiment, and detailed descriptions thereof are omitted.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A ratchet assembly comprising:
a housing being hollow and having
a front face;
a rear face;
a fixing space formed in the housing; and
two openings formed through the front face and the rear face of the housing respectively and communicating with the fixing space;
a ratchet element mounted in the fixing space of the housing and having
an inner circumferential surface; and
a toothed face formed on the inner circumferential surface of the ratchet element; and
a sleeve fixing device mounted through the housing horizontally, engaged with the ratchet element, and having
a sleeve fixing element mounted in the fixing space of the housing and having
an end extending out of one of the two openings of the housing;
a rotation portion having
a front face; and
a mounting hole formed in the front surface of the rotation portion;
a rotating element mounted through the mounting hole of the rotation portion;
a reverting support mounted through the rotating element and having
a moveable barrel having a first end and a second end;
a rotating ball rotatably mounted in the second end of the moveable barrel;
a spring mounted in the first end of the moveable barrel; and
an abutting element extending into the first end of the moveable barrel and mounted around the spring; and
a ratchet block pivotally connected to the sleeve fixing element and having
an inner surface engaged with the rotating ball of the reverting support; and
an end engaged with the toothed face of the ratchet element.

2. The ratchet assembly as claimed in claim 1, wherein the abutting element has
an abutting barrel; and
an abutting ball rotatably mounted in the abutting barrel;
the abutting ball rotatably abuts the mounting hole of the sleeve fixing element; and
one end of the spring is mounted into and abuts the abutting barrel.

3. The ratchet assembly as claimed in claim 2, wherein the abutting barrel has
a first end;
a second end;
a disposing recess formed in the first end of the abutting barrel, one end of the spring extending into and abutting the disposing recess of the abutting barrel; and
an abutting ball recess formed in the second end of the abutting barrel; and
the abutting ball is rotatably mounted in the abutting ball recess of the abutting barrel.

4. The ratchet assembly as claimed in claim 1, wherein the abutting element is a cylindrical barrel and has
a first end;
a second end;
a receiving recess formed in the first end of the abutting element, and one end of the spring extending into and abutting the receiving recess of the abutting element; and
an abutting protrusion protruding from the second end of the abutting element; and
the abutting protrusion abutting the mounting hole of the sleeve fixing element.

5. The ratchet assembly as claimed in claim 1, wherein the inner surface of the ratchet block has three positioning recesses, the three positioning recesses are wave-shaped, and the reverting support is engaged with one of the three positioning recesses.

6. The ratchet assembly as claimed in claim 2, wherein the inner surface of the ratchet block has three positioning recesses, the three positioning recesses are wave-shaped, and the reverting support is engaged with one of the three positioning recesses.

7. The ratchet assembly as claimed in claim 3, wherein the inner surface of the ratchet block has three positioning recesses, the three positioning recesses are wave-shaped, and the reverting support engages with one of the three positioning recesses.

8. The ratchet assembly as claimed in claim 4, wherein the inner surface of the ratchet block has three positioning recesses, the three positioning recesses are wave-shaped, and the reverting support engages with one of the three positioning recesses.
